(19) United States
(12) Patent Application Publication
(10) Pub. No.: US 2005/0028189 A1
(43) Pub. Date: Feb. 3, 2005

(54) System to provide access to information related to a broadcast signal

(76) Inventors: Jeffrey Heine, Hertfordshire (GB); Robert Kilbride-Newman, Hertfordshire (GB); Robert Flint, Bucks (GB)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/777,489

(22) Filed: Feb. 12, 2004

Related U.S. Application Data
(63) Continuation of application No. PCT/GB02/03628, filed on Aug. 6, 2002.

(30) Foreign Application Priority Data
Aug. 14, 2001 (GB) GB 0119755.7
Apr. 26, 2002 (GB) GB 0209547.9

(51) Int. Cl. H04N 7/16; H04N 7/173; H04N 7/167; H04H 9/00

(52) U.S. Cl. 725/20; 725/30; 725/31; 725/109; 725/112

(57) ABSTRACT

A system to provide access to information related to an audio or video signal being distributed to a multiplicity of people at a given time includes a watermarking arrangement for inserting identification codes into the audio or video signal before or at the time of distribution, the codes consisting of information identifying the time of distribution and the identity of the distributor, a reader for reading the identification codes and associating a block of data stored in a data store with the identification codes, and a communicator, such as, a mobile phone for one or more person who has received the audio or video signal to access the block of data using either the identification codes or the identity of the distributor and the time of distribution.

### RELATED APPLICATION

This application is a continuation of International Patent Application No. PCT/GB02/03628 filed Aug. 6, 2002, which is here incorporated by reference in its entirety. The benefits of 35 USC 120 are claimed.

### BACKGROUND OF THE INVENTION

### FIELD OF THE INVENTION

This invention describes system and method to provide access to information related to a broadcast signal.

### PRIOR ART

Our co-pending patent application GB0119755.7 describes a method of embedding an inaudible digital watermark in audio broadcast material. The listener can then use a mobile wireless device, such as a WAP phone or wireless to enabled portable digital assistant, to decode this watermark and direct the listener to an internet site that is relevant to the audio material. WO01/15357 discloses a system having a number of similarities, but using a personal computer rather than a mobile wireless device.

### SUMMARY OF THE INVENTION

The present application describes an alternative method by which the listener can access further material relevant to audio/video broadcast material. It has the advantage that the listener does not need to have a decoder, and can access the further material using standard mobile phone technology. Also, the delivery of further material is not limited to Internet access, but can be via audio, SMS and MMS services. One aspect of this invention is that the audio/video content is identified by the time of its broadcast, and so is usable with live audio broadcast material.

The present invention uses two pieces of information, supplied by the listener, to access further information on broadcast material: the broadcaster and the time of broadcast of interest to the listener. Other systems have tried similar approaches but have been unsuccessful. These other systems use a dedicated portable device to record the times of interest, and at a later delayed time, the portable device is connected to an internet-ready PC and the stored times are downloaded to the PC. The PC then acquires the further material via a database on the Internet.

The present invention does not require a dedicated device, but works with standard mobile phone technology and can be instantaneous, not delayed.

Also, the known systems only provide half a solution. They provide a system for the listener to record times of interest and obtain further information, but they require the broadcaster provide and maintains accurate broadcast times. Known systems do not provide a mechanism to do this. Accurate time of broadcast information is relatively easily generated for pre-recorded ‘music only’ radio broadcasts. It is much more difficult to provided accurate time of broadcast information for ‘live’ radio broadcasts.

Although the present invention requires time of broadcast information, it includes a mechanism for obtaining this information using digital watermarking technology.

Music recognition services using mobile or landline phones are known based on passive music recognition technologies. In these systems, the listener phones a server and plays the music of interest down the phone line. The server analyses short sections of the music, typically 15 seconds, and extracts a characteristic fingerprint that is used as a key to locate relevant information. These systems work directly from the music, hence the label ‘passive’, and do not require modification to the audio signal such as the addition of a watermark. The source of music is not limited to broadcast material. The system is limited in that the characteristic fingerprint is not guaranteed to be unique to a single item of audio music. Also, the system cannot distinguish the context that the music was played in, i.e. whether the music was played by a particular radio station, was on recorded media, etc.

The present invention does provide a unique key and a context for broadcast items: the broadcaster and time of broadcast. So the listener accurately gets to the item of interest, and the information for a particular audio item can vary from broadcaster to broadcaster and even between different times of broadcasting by the same broadcaster. This is of great interest to the broadcaster since they are therefore included in the business model, whereas in other systems they are specifically bypassed.

According to the present invention there is provided a system for providing access to information related to an audio or video signal being distributed to a multiplicity of people at a given time, as specified in the claims.

### BRIEF DESCRIPTION OF THE DRAWINGS

Embodiments of the invention will now be described, by way of example only, with reference to the accompanying schematic drawings, in which:

FIG. 1 shows a system according to the present invention,

FIG. 2 shows the system of FIG. 1 with automated insertion of broadcast time information, and

FIG. 3 shows a system in which each listener or viewer has a watermark code decoder.

### DETAILED DESCRIPTION OF PREFERRED EMBODIMENTS

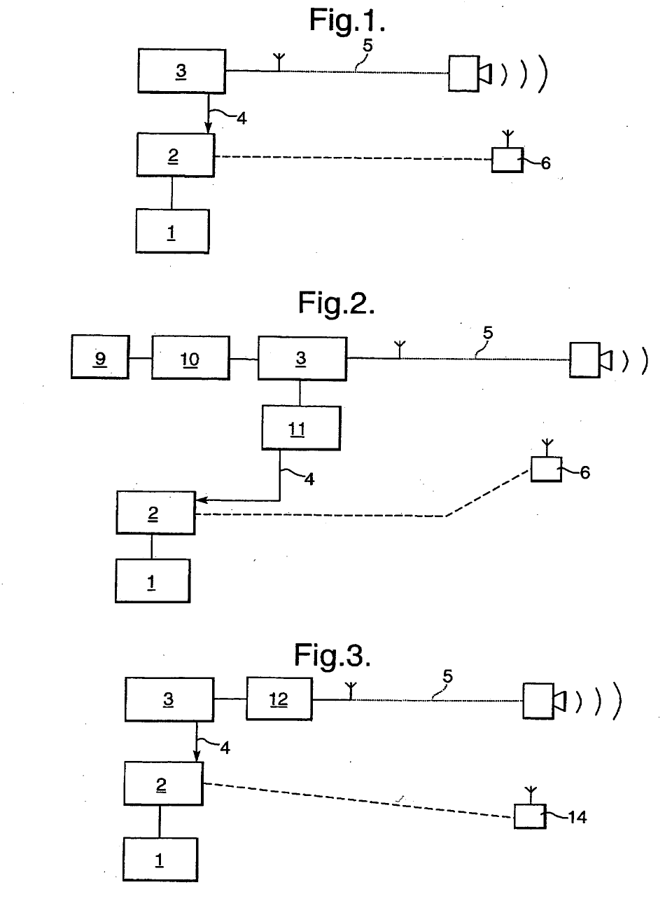

In a first aspect, the invention describes a method for providing relevant material to listeners or viewers using standard mobile phones (see FIG. 1). First the broadcaster generates material that is relevant to the items that they will broadcast (1) and stores this material in a database (2). The database can be administered by the broadcaster or by a separate database service provider. Generic or default material may be generated that will be used for items that do not have any specific material associated with them. The broadcaster then broadcasts the items (3) and informs the database server of the item currently being broadcast (4). In this way the database server can associate every item with its time of broadcast. The listener hears or sees an item of interest, via the transmission channel (5) and immediately uses their mobile phone (6) to connect to the database server (2). The database server registers the time of access by the listener and correlates this with the broadcast times of the items to establish the item of interest to the listener. The database server then sends the material associated with the item to the listener via their mobile phone (6).

The format of the material sent by the server can be of various and multiple formats, compatible with the formats used by mobile phones. For example,
a) The listener could phone the database server via a standard audio phone line. The database server would look like a call centre, providing automated material via interactive voice response or other material via human operators.
b) b) providing pre-recorded and/or automated audio material and/or material via a human operator.
c) The listener could send an SMS or MMS message to the database server. The server would then send the relevant material as an SMS/MMS message back to the listener.
d) The listener could access the database server via a specific WAP or HTTP address. The relevant material will be given via WAP or HTTP pages.

The broadcaster must supply the database server with broadcast times for all audio items broadcast (4). If the broadcast is pre-recorded, the audio item play list and associated times can be prepared in advance at the time of recording. If the broadcast is live, an alternative method is required. One alternative method involves the use of inaudible digital watermarks (FIG. 2). The broadcaster embeds inaudible digital audio watermarks in selected items using an encoder (9). These items will be the ones for which the broadcaster has generated further material stored in the database. Each item can have a unique watermark. This may be done in advance of broadcast, for instance when the associated material is generated and stored in the database (2). These content encoded items are stored with other broadcastable material (10). The stored watermarked items are then broadcast, together with other un-watermarked items that do not have any specific material in the database (3). Any known watermarking technique may be used for encoding, however that disclosed in EP 0 245 037, EP 0 366 381 or EP 0 801 855 is preferred.

The broadcaster also has a watermark decoding device (11) listening to the broadcast material in real-time. The decoding device identifies the unique watermark embedded in the broadcast material, or that no watermark is embedded. In this way, the decoding device working ‘live’ establishes the broadcast times of watermarked and un-watermarked items. This information is relayed to the database server (4). Un-watermarked items are associated with the generic/default material in the database supplied by the broadcaster.

The embedding and decoding of watermarks is the same as described in our co-pending patent application GB0119755.7. However in the present invention there is only one decoder operated by the broadcaster, rather than having decoders with all listeners/viewers. Also, the decoder can be located at the front-end of the broadcast transmission chain, i.e. before the material is transmitted over wire and/or radio waves and/or air etc. to the listener/viewer. Locating the decoder at the front of the transmission chain eliminates the noise added by the transmission chain, enabling better recovery of watermarks.

If the database server is simultaneously managing information from multiple broadcasters, the listener/viewer must provide the database server with the broadcaster of interest when it accesses the server. In most situations the listener knows the broadcaster they are listening to. In this case the listener manually selects the broadcaster of interest. This could be achieved in a number of ways.
a) The database server has a different access SMS/MMS/WAP/web address/phone number for each broadcaster, and the listener selects the appropriate access address.
b) The database server has a single access SMS/MMS address, and the listener sends the broadcaster name in the text of the message.
c) The database has a single access WAP/web address that accepts parameters to the page. The listener specifies the broadcaster as a page parameter.

These operations can be made user-friendly for the listener with a simple application (e.g. in Java) running on their phone, if the phone has this capability. A further scheme is possible where the specification of the broadcaster is automated. In this scheme, the broadcaster embeds a watermark in to the broadcast material, and the listener has a decoder. This is the same scheme as described in GB0119755.7, except that the watermark identifies the broadcaster, rather than the audio content. The scheme works as follows (see FIG. 3). Each broadcaster has a unique watermark. This watermark is embedded in to broadcast material (12). The listener activates their decoder (14) when they hear/see an item of interest. The viewer/listener's decoder extracts the to broadcaster watermark, and automatically sends this information to the database server (2). The server now has broadcaster and time of broadcast and can retrieve the relevant material (1). A convenient place to locate the broadcaster encoder (12) is at the front end of the transmission chain (5). The viewer/listener's decoder (14) could be a separate device or could be an application running on the listener's phone.

There are a number of advantages to this automated scheme.
a) The automated scheme allows a simple ‘one-touch’ operation for the listener/viewer. The listener needs only to fire up the application. This can often be mapped to a single key press.
b) The listener/viewer does not need to know the broadcaster before using the service. The scheme allows the listener/viewer to find out the broadcaster and for the broadcaster to identify themselves to potentially new customers (and hence revenue sources).
c) By identifying the broadcaster instead of the content, the context of the audio material is identified. This enables the material sent to the listener/viewer to be more selectively targeted. For example, a song played by a radio station broadcaster could be associated with material about when the song or artist will next be on the radio station, whereas the same song played by a music retailer, broadcast inside their stores could be associated with material about price, where to find it etc.
d) By using the time of broadcast to identify the content instead from an embedded code, the context of the audio material is further enhanced. A broadcaster can associate different material for a song played at different times of the day. For example, each radio show may have its own web page. The information about the song could appear in the appropriate show web page depending on time of broadcast.

Although in all of the above schemes the listener accesses the database server immediately they hear an item of interest, a scheme is possible whereby the listener's phone runs an application that simply logs the time of interest locally, and the database server is accessed at a later delayed time. The listener provides the stored time of interest to the database server upon delayed access.

Alternatively, the listener can manually enter previous times of interest, as a method of searching the database.

In summary, the present invention can provide the following features:
1. The use of conventional mobile phones to allow consumers to access context dependent information associated with broadcast material.
2. Using the time of broadcast and broadcaster as a key to the material of interest.
3. Using audio, SMS, MMS, and Internet protocols to obtain this information, via the listener's mobile phone.
4. Using digital watermark technology to enable the broadcaster to obtain time of broadcast information for items.
5. Using digital watermark technology to enable the listener to identify the broadcaster of material.

1. A system for providing access to information (1) related to an audio or video signal (12) being distributed to a multiplicity of people at a given time, the system including or consisting of watermarking means (9) for inserting identification codes into said audio or video signal before or at the time of distribution, said codes consisting of or including information identifying the time of distribution and the identity of the distributor, to means (14) for reading the identification codes and associating a block of data stored in a data store with said identification codes, and communication means (6) for one or more person who has received said audio or video signal to access said block of data using either said identification codes or the identity of the distributor and the time of distribution.

2. A system as claimed in claim 1 in which the data store is a server, and the communication means includes a telephone which accesses the server via a computer network, WWW or WAP pages, text messaging, or interactive voice response means.

3. A system as claimed in claim 1 in which the data store is connected to means (11) for decoding said identification codes such that the time of broadcast of a given audio or video item is recorded in said data store.

4. A system as claimed in claim 1 in which the communication means includes means to decode and store said identification codes.

5. A system as claimed in claim 2 in which the communication means includes means to decode and store said identification codes.

6. A system as claimed in claim 3 in which the communication means includes means to decode and store said identification codes.
